(19) United States
(12) Patent Application Publication
(10) Pub. No.: US 2007/0017055 A1
(43) Pub. Date: Jan. 25, 2007

(54) Windshield wiper scrubber adapter

(76) Inventor: David T. Simko, Knoxboro, NY (US)

Correspondence Address: DAVID GIGLIO, ESQ., 231 ELIZABETH STREET, UTICA, NY, 13501, US

(21) Appl. No.: 11/187,317

(22) Filed: Jul. 25, 2005

(51) Int. Cl. B60S 1/28; B60S 1/38

(52) U.S. Cl. 15/250.41; 15/250.4; 15/250.361

(57) ABSTRACT

There is provided a windshield wiper scrubber adapter that is adapted to be integrated with a standard windshield wiper system. The scrubber adapter includes a scrubbing member that is manufactured from, preferably, a porous nylon material. A standard rubber wiper tread cooperates with the scrubbing member to provide both a scrubbing effect and a squeegee effect to clear foreign matter from an automobile windshield.

### FIELD OF THE INVENTION

The present invention relates generally to the field of windshield wipers and, more particularly to a windshield wiper scrubber adapter.

### BACKGROUND OF THE PRESENT INVENTION

Windshield wipers are a common known necessity installed in every automobile. A windshield wiper motor is mounted under the front head adjacent to the bottom of the front windshield. The wiper motor arcuately rotates a wiper arm back and forth across the front of the windshield.

A windshield wiper includes a wiper housing and a wiper tread that are mounted to the end of the wiper arm. The wiper arm urges the windshield wiper against the front surface of the windshield.

The wiper tread acts a squeegee and presses against the windshield surface, thereby pressing and sweeping loose foreign material and fluid to one side or the bottom of the windshield. The fluid comes in the form of rain or stored washer fluid pumped from an internal reservoir under the hood.

When it is raining with a steady downfall, the amount of fluid presented to the windshield is sufficient to loosen any foreign matter that is adhered to the windshield surface. This foreign matter and the fluid is then squeegeed or swept away by the wiper tread. Typically the wiper tread is a rubber material that extends the length of the wiper housing and has a small width.

When it is not raining, windshields tend to accumulate all kinds of foreign matter including dust, dirt, bird droppings, splattered insects and the like. During hot weather, these foreign matters quickly adhere to the windshield surface, thus making visibility difficult.

One method of removing the foreign matter during these non-raining driving sessions is to pump washer fluid onto the windshield and attempt to loosen the foreign matter with combination of the washer fluid and the rubber tread. However, the rubber tread and washer fluid are often inadequate to substantially remove the foreign matter. In fact, often times this action spreads the foreign matter across a greater surface area of the windshield making visibility even worse. Usually a great amount of washer fluid must be pumped onto the windshield to provide effective removal of the foreign matter.

During some seasons or in some areas, foreign matter quickly accumulates back onto the windshield, making repeated cleaning attempts necessary. A great amount of washer fluid is thus expended during a short drive. For long drives, it is common for the reservoir to become empty because of the amount of fluid necessary to keep this foreign matter from the disrupting the driver's vision. It is sometimes necessary to carry spare washer fluid, pull the car over, lift the front hood and refill the reservoir.

Further, the repeated use of the wiper tread to attempt to loosen the foreign matter quickly wears away this delicate tread and it is then necessary to replace the worn wipers.

### SUMMARY AND OBJECTS OF THE PRESENT INVENTION

It is an object of the present invention to improve the art of automobiles.

It is a further object of the present invention to improve the art of windshield wiper systems of the present invention.

It is another object of the present invention to provide a windshield wiper scrubber adapter that fits within standard windshield wiper systems.

It is yet another object of the present invention to provide a windshield scrubber adapter that scrubs rather than wipes or squeegees away foreign matter from an automobile windshield.

It is a feature of the present invention to provide a windshield scrubber adapter that is adaptable to a windshield wiper system and includes a porous scrubber having a sufficient surface are to effectively scrub foreign matter loose from an automobile windshield.

These and other objects and features are described herein in which there is provided a scrubber adapter for a windshield wiper system. The windshield wiper system includes a wiper motor having a rotating wiper arm mounted thereto. The windshield wiper system further includes a wiper blade housing mated at an opposing end of the rotating wiper arm and a standard wiper tread mounted within the wiper blade housing.

The scrubber adapter includes a scrubber adapter housing, a scrubbing member mounted to the scrubber adapter housing, and coupling means for coupling the wiper blade housing with said adapter blade housing.

The scrubbing member is typically porous nylon material. Although one skilled in the art can readily determine additional material that work satisfactorily with the aims and goals of the present invention. The scrubbing member has a preferred windshield surface width of approximately one-half inch, more or less.

The windshield wiper housing and the adapter housing are mated through a number of varying means. In one embodiment, a connecting pin is inserted through axially aligned openings in both the wiper housing and the adapter housing and fixed therein with cotter pins. Obviously, a number of connecting means and apparatus may be used to couple the two housings.

In another embodiment, the windshield wiper adapter further includes a wiper tread of its own adjacently mounted to the scrubbing member. The standard windshield wiper is thus removed and the windshield wiper adapter of the present invention is installed. Thus, both scrubbing and squeegeeing is provided.

### BRIEF DESCRIPTION OF THE DRAWINGS

The present invention will be understood and appreciated more fully from the following detailed description taken in conjunction with the drawings in which:

FIG. 1 is a side elevation view of a preferred embodiment of the scrubber adapter of the present invention;

FIG. 2 is a side view of the adapter scrubber in use in accordance with the present invention;

FIG. 3 is a side elevation view of a standard wiper blade of the prior art;

FIG. 4 is bottom view of the scrubber adapter depicted in FIG. 1 in use in accordance with the preferred embodiment of the present invention;

FIG. 5 is a side elevation view showing details to secure the scrubber adapter to the standard wiper blade in accordance with a preferred method of the present invention; and

FIG. 6 is an alternative embodiment of the scrubber adapter of the present invention.

### DETAILED DESCRIPTION OF THE PRESENT INVENTION

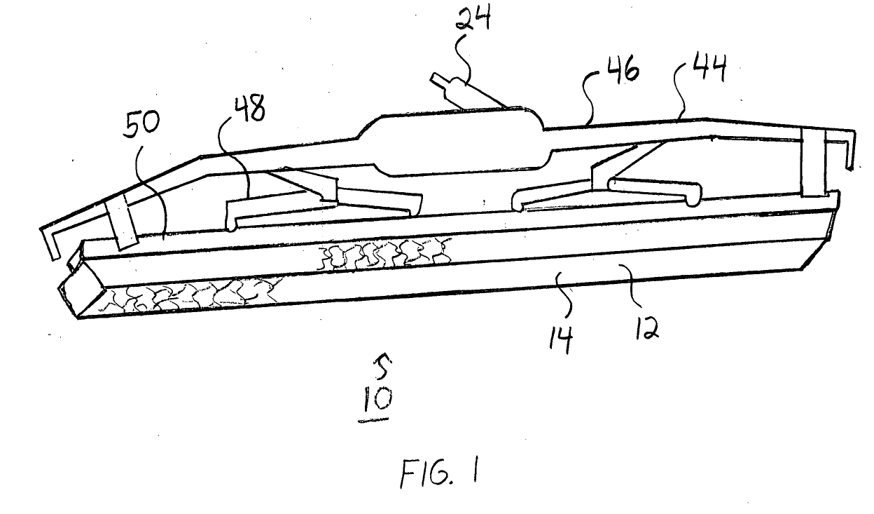

The present invention shall now be described in accordance with a preferred embodiment of a scrubber adapter isolated from a windshield wiper system and then installed in accordance with the windshield wiper system. Referring now the FIG. 1, the scrubber adapter 10 includes a scrubbing member 12 which is generally manufactured from a porous nylon material, such as buffing pad material manufactured and sold by Niagara™ corporation of Tonawanda, N.Y. This buffing pad material is made to work and last under 150 pounds per square inch at between 175-600 revolutions per minute.

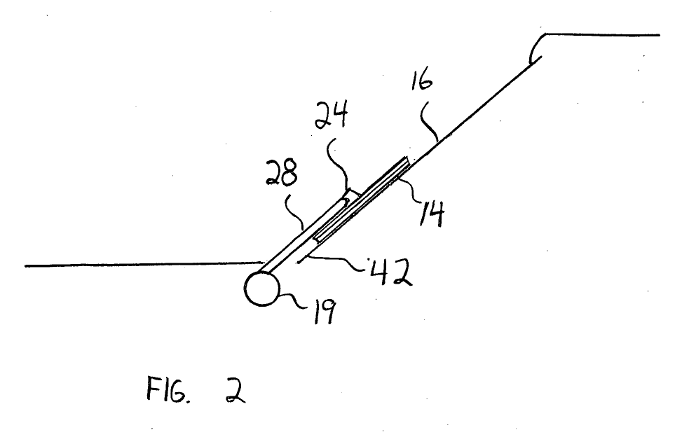

The scrubbing member 12 does not easily wear down and become useless in accordance with its use in the present invention. Further, the scrubbing member 12 presents a contact surface design 14 which has a small amount of frictional force between the contact surface 14 and a windshield 16, depicted in FIG. 2, when in use. Thus, there is a light drag on a wiper motor 19 thereby preventing motor burnout.

The scrubbing member 12 is porous so that fluid and foreign material readily passes there through so that the scrubbing member 12 does not become weighted down with absorbed material. In this manner the integrity of the scrubbing member 12 is quickly restored to its initial state after use.

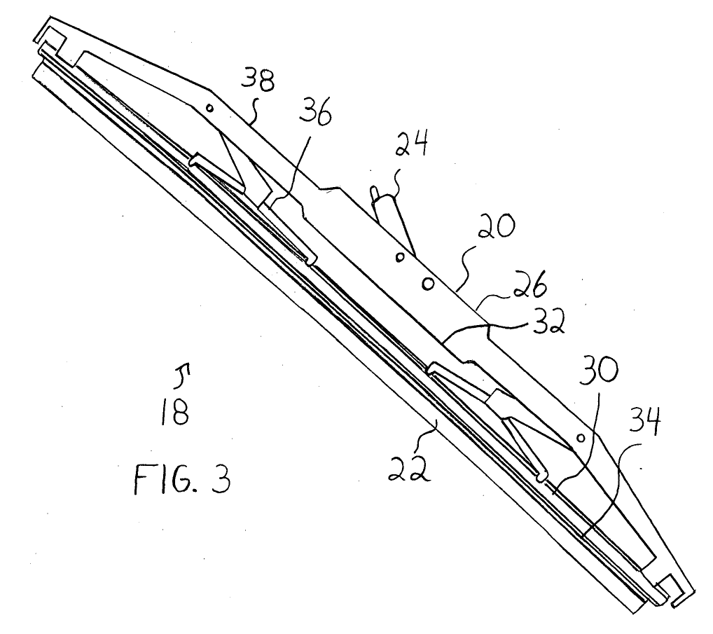

Before describing the remainder of the scrubber adapter 10 it is necessary to describe a standard wiper blade 18 of the present art. Referring now to FIG. 3, the standard wiper blade 18 includes a wiper blade housing 20 and a wiper tread 22. A mating member 24 from a top surface 26 of the wiper blade housing 20 mates with a wiper arm 28 (depicted in FIG. 2), which extends from the wiper motor 19. In such a manner, as the wiper arm 28 rotates back and forth, the wiper blade housing 20 follows a back and forth arcuate path across the windshield 16.

A track member 30 extends from the bottom surface 32 of the wiper blade housing 20. A rail member 34 extends the length of the wiper tread 22 and fits in the track member 30 to secure the wiper tread 22 to the wiper blade housing 20.

Typically, the wiper blade housing 20 includes flexible members 36 extending between a back shell 38 and the track member 30. The flexible members 36 allow a certain amount of flexibility so that the wiper tread 22 and track member 30 conforms with the shape of the exterior surface of the windshield 16. The wiper arm 28 forces the standard wiper blade 18 to the windshield 16.

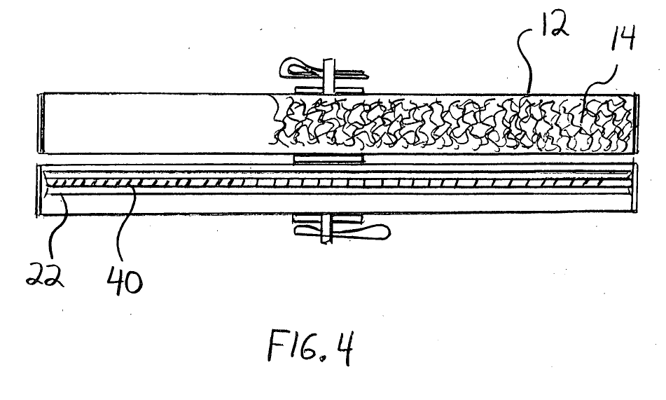

Referring now to a bottom view of a preferred embodiment of the present invention depicted in FIG. 4, the wiper tread 22 includes a narrow contact surface 40 also extending the length of the wiper tread 22. As the wiper tread 22 rotates arcuately back and forth across the windshield 16 the narrow contact surface 22 acts as a squeegee and quickly removes a certain amount of foreign matter and fluid, if raining or if windshield washer fluid is sprayed on the windshield 16, to a lateral edge (not depicted) of the windshield 16 or at to the bottom 42 of the windshield 16.

When there is a significant amount of foreign material adhered to the windshield 16, the wiper tread 22 is insufficient to remove the material, unless a constant stream of fluid is applied to the windshield 16, because its surface area in contact with the windshield 16 is minimal through each stroke of the motor 19.

Turning back to the scrubber adapter 10, a scrubber adapter housing 44 includes a back shell 46 and flexible members 48 having similar dimensions to the back shell 38 and flexible members 36 of the standard wiper blade housing 20. A track member 50 again extends from the flexible members 48 substantially the entire length of the back shell 46.

The scrubbing member 12 in a preferred embodiment is adhered to the track member 50 using a plastic welding material (not shown). The plastic welding material sells under the trademarked name of Devcon®. It should be apparent that many various apparatus and methods can be used to secure the scrubbing member 12 to the scrubber adapter housing 44 and still fit within the spirit and scope of the present invention. In fact, the track member 50 of the adapter housing 44 can be any shaped member if the plastic welding material is used.

The back shell 46 of the scrubber adapter housing 44 may also include a mating member 24 extending from its top surface for mating with the wiper arm 28.

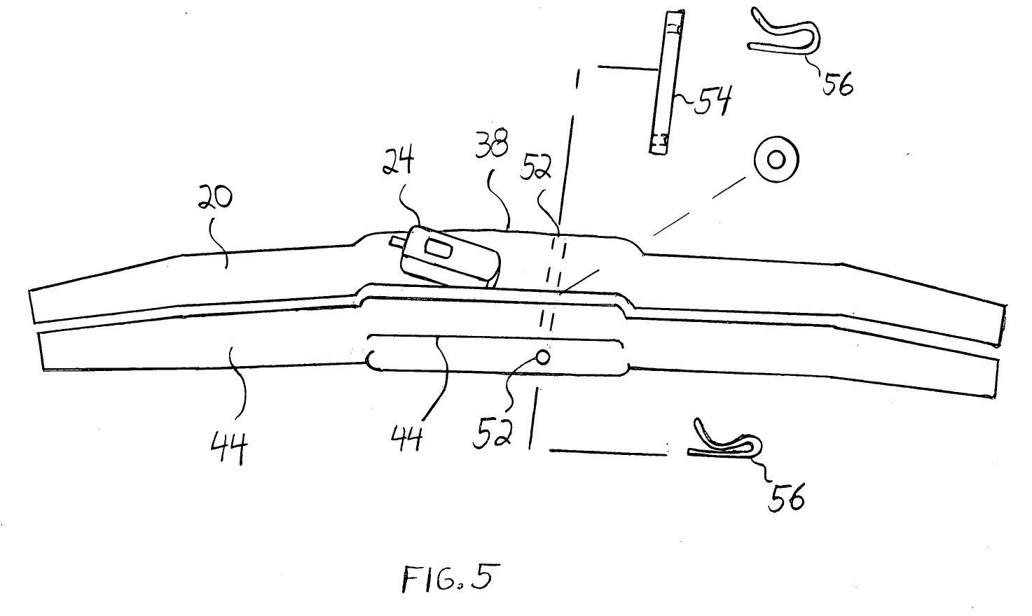

Turning now to FIG. 5 there is shown how to adapt the scrubber adapter 10 to the standard wiper blade 18. The back shell 46 of the scrubber adapter housing 44 and the back shell 38 of the standard wiper housing 20 each include openings 52 therethrough. The openings 52 are axially aligned so that the two housings 44, 20 are mated via a pin 54 inserted therethrough and a pair of cotter pins 56. It should be obvious to one skilled in the art that many other methods are sufficient to mate the scrubber adapter housing 44 to the standard wiper housing 20.

In the embodiment just described, the scrubber adapter 10 can be quickly installed for seasonal use and removed when not needed.

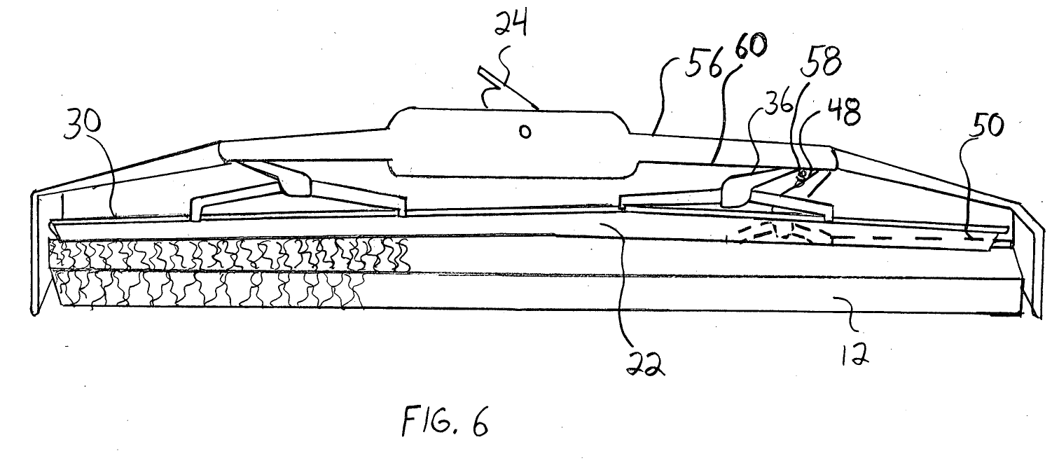

In an alternative embodiment of the present invention and depicted in FIG. 6, a scrubber adapter housing 56 includes two pairs of flexible members 36, 48 and two pairs of track members 30, 50 disposed thereon. The standard wiper tread 22 is mated to one track member 30 as previously described herein, while the scrubbing member 12 is mated to the other track member 50. In this alternative embodiment the standard wiper blade 18 is removed from the wiper arm 28 and the scrubber adapter housing 56 is mated to the wiper arm 28 using the mating member 24.

In use with either the preferred embodiment or the alternative embodiment, the scrubbing member 12 has a width of between one quarter of an inch and one inch, with approximately one half inch being preferred. Thus, as the wiper arm 28 rotates arcuately back and forth, and with some fluid being applied, the scrubber member 12 contacts such a large surface area of the windshield 16 over a single motor 19 stroke that most of the foreign matter adhered to the windshield 16 is either removed or loosened. The wiper tread 22 squeegees away the loosened foreign matter and the excess fluid from the windshield 16. Thus, the wiper tread 22 and the scrubbing member 12 cooperate to quickly clean the windshield 16.

A spring 58 installed between the back shell 60 of the adapter housing 56 and either/or both of the flexible members 36, 48 urges the flexible members 36 and/or 48 toward the windshield 16. Thus, the scrubbing member 12 and wiper tread 22 evenly come into contact with the windshield 16 even if one of the scrubbing member 12 or wiper tread 22 wears away quicker than the other.

The porous design of the scrubbing member 12 allows the foreign matter and the fluid to quickly pass therethrough, thus allowing the scrubbing member 12 to quickly restore itself to its initial shape and saturation.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. A scrubber adapter for a windshield wiper system, wherein said windshield wiper system includes a wiper motor having a rotating arm mounted thereto at a first end of said rotating arm, and said windshield wiper system further includes a wiper blade housing mated with a second end of said rotating arm and a standard wiper tread mounted within said wiper blade housing, said adapter comprising:
a scrubber adapter housing;
a scrubbing member mounted to said scrubber adapter housing; and
adapter mating means for integrating said adapter blade housing into said windshield wiper system.

2. The scrubber adapter of claim 1, wherein said scrubbing member is manufactured from a porous nylon material.

3. The scrubber adapter of claim 1, wherein said scrubbing member has a windshield surface width of at least one-quarter inch.

4. The scrubber adapter of claim 1, wherein said scrubbing member has a windshield surface width of between one-eighth inch and two inches.

5. The scrubber adapter of claim 1, wherein said adapter mating means further includes a coupling means for coupling the scrubber adapter housing with the wiper blade housing.

6. The scrubber adapter of claim 5, wherein said adapter mating means further includes a rotating arm mating means for mating said scrubbing adapter housing to the second end of said rotating arm.

7. The scrubber adapter of claim 5, wherein said wiper blade housing and said scrubber adapter housing each include an opening that is axially aligned with the other and said housing coupling means includes a connecting rod disposed through each opening.

8. The scrubber adapter of claim 1, further including an adapter wiper tread affixed to said scrubber adapter housing, said adapter wiper tread being substantially parallel situate with said scrubbing member.

9. The scrubber adapter of claim 8, wherein said adapter mating means further includes a rotating arm mating means for mating said scrubbing adapter housing to the second end of said rotating arm.

10. The scrubber adapter of claim 1, further including a spring means disposed between the scrubber adapter housing and said scrubbing member which urges said scrubbing member away from the scrubber adapter housing.

11. A windshield wiper system comprising:
a wiper motor;
at least one rotating arm mounted at a first end to said wiper motor;
at least one wiper housing mated to a second end of said at least one rotating arm;
a standard wiper tread affixed to said at least one housing; and
a scrubbing member affixed to said at least one housing.

12. The windshield wiper system of claim 11, wherein said scrubbing member is manufactured from a porous nylon material.

13. The windshield wiper system of claim 11, wherein said scrubbing member has a windshield surface width of at least one-quarter inch.

14. The windshield wiper system of claim 11, wherein said scrubbing member has a windshield surface width of between one-eighth inch and two inches.

15. The windshield wiper system of claim 11, wherein said at least one wiper housing further includes a standard wiper housing, a scrubber adapter housing and mating means for coupling said standard wiper housing to said scrubber adapter housing, and wherein said standard wiper tread is affixed to said standard wiper housing and said scrubbing member is affixed to said scrubber adapter housing.

16. The windshield wiper system of claim 15, wherein said mating means further includes a rotating arm mating means for mating said at least one housing to the second end of said rotating arm.

17. The windshield wiper system of claim 15, wherein said standard wiper blade housing and said scrubber adapter housing each include an opening that is axially aligned with the other and said mating means includes a connecting rod disposed through each opening.

18. The windshield wiper system of claim 11, wherein said at least one housing further includes a scrubber adapter housing, and wherein said standard wiper tread and said scrubbing member are both affixed to said scrubber adapter housing
